(19) United States
(12) Patent Application Publication
(10) Pub. No.: US 2012/0040257 A1
(43) Pub. Date: Feb. 16, 2012

(54) Fuel Container For Fuel Cell, Fuel Cell Using The Same, And Operation Method Of Fuel Cell

(76) Inventors: Hideaki Sasaki, Tokyo (JP); Shin Nakamura, Tokyo (JP); Shoji Sekino, Tokyo (JP); Yoshimi Kubo, Tokyo (JP)

(21) Appl. No.: 10/598,737

(22) PCT Filed: Feb. 21, 2005
(86) PCT No.: PCT/JP05/02697

§ 371 Date: Sep. 8, 2006

(30) Foreign Application Priority Data
Mar. 10, 2004 (JP) 2004-068230

(51) Int. Cl. H01M 8/04; F16K 24/04; H01M 8/06

(52) U.S. Cl. 429/414; 429/513; 137/197; 429/515

(57) ABSTRACT

An object of the present invention is to downsize a fuel cell, and to stably supply fuel to a fuel electrode. According to the present invention, the above described object is attained by providing a vaporized fuel container 1518 communicated with a liquid fuel container 1517 via a gas liquid separating film 1519 in the fuel cell 1516, in which a liquid fuel 124 supplied to a fuel electrode 102 is stored.

### TECHNICAL FIELD

The present invention relates to a fuel container for fuel cell, a fuel cell using the same, and an operation method of fuel cell.

### BACKGROUND ART

A solid electrolyte fuel cell is constituted by a fuel electrode, an oxidant electrode, and a solid electrolyte membrane provided between the fuel electrode and the oxidant electrode, and performs power generation according to the electrochemical reaction caused by supplying fuel to the fuel electrode and by supplying an oxidizing agent to the oxidant electrode. The fuel electrode and the oxidant electrode include a base material and a catalyst layer which is formed on the surface of the base material. In the fuel cell, hydrogen is generally used as a fuel, but a methanol reforming type fuel cell in which inexpensive and easily-handling methanol is used as a raw material so as to generate hydrogen by reforming the methanol, and a direct type fuel cell in which methanol is used directly as a fuel, has been energetically developed.

When methanol is used as a fuel, the reaction in the fuel electrode is expressed by the following formula (1).

CH₃OH+H₂O→6H⁺+CO₂+6e⁻ (1)

Further, the reaction in the oxidant electrode is expressed by the following formula (2).

3/2O₂+6H⁺+6e⁻→3H₂O (2)

In this way, in the direct type fuel cell, it is possible to obtain hydrogen ions from a methanol aqueous solution, to make it possible to eliminate a reforming device and the like, and to thereby attain size reduction and weight reduction of the fuel cell. Further, since a liquid methanol aqueous solution is used as fuel, it has a characteristic that the energy density is very high.

In Patent Document 1, there is disclosed a technique in which a liquid fuel is supplied to an external fuel cell from a liquid fuel container storing the liquid fuel. In the fuel cell disclosed in Patent Document 1, the liquid fuel stored in the liquid fuel container is supplied to the main body from an introduction pipe, and is vaporized in a vaporizing section of the main body, to be introduced into a fuel electrode.

However, this fuel cell is constituted such that the liquid fuel in the liquid fuel container is vaporized in the vaporizing section provided before the fuel electrode in the main body, to be introduced into the fuel electrode. For this reason, there is a problem to be improved in adjusting the fuel supplied to the fuel electrode to a predetermined concentration.

On the other hand, in Patent Document 2, there is disclosed a fuel cell which has a high concentration methanol tank in addition to a fuel tank storing a liquid fuel to be supplied to a unit cell. However, in this case, it is necessary to supply a high concentration methanol stored in the high concentration methanol tank to the fuel tank by a pump, to adjust the liquid fuel supplied to the unit cell to a predetermined concentration. This causes the apparatus constitution to become large-sized and complicated.
Patent Document 1: Japanese Patent Application Laid-Open No. 2001-93551.
Patent Document 2: Japanese Patent Application Laid-Open No. 2003-132924.

### DISCLOSURE OF THE INVENTION

### Problem to be Solved by the Invention

The present invention has been made in view of the above described circumstances, and an object of the present invention is to provide a technique which makes it possible to downsize a fuel cell and to stably supply a fuel to a fuel electrode.

### Means for Solving Problem

According to the present invention, there is provided a fuel container for fuel cell in which a solid or liquid fuel is placed, comprising a fuel gas supply port for supplying vapor of the fuel stored in the container to a liquid fuel supply system of the fuel cell.

The fuel container for fuel cell according to the present invention comprises the fuel gas supply port. The fuel supply to the fuel electrode of the fuel cell is performed by the liquid fuel supply system. For this reason, the vapor of the fuel stored in the container can be dissolved in the liquid fuel supply system of the fuel cell, and surely supplied to the fuel electrode. When the fuel component concentration of the liquid fuel stored in the liquid fuel supply system is lowered due to the use of the fuel cell, it is possible to supply the fuel, and to thereby stabilize the fuel concentration in the liquid fuel supply system. Further, the supply is performed after dissolving the vapor of fuel into the liquid fuel, so that the fuel can be stably supplied without using an auxiliary apparatus such as a pump for supplying the fuel component to the liquid fuel supply system. For this reason, by the use of the fuel container for fuel cell according to the present invention, it is possible to stably operate the liquid fuel supply type fuel cell with simple constitution.

According to the present invention, there is provided a fuel container for fuel cell, comprising: a fuel placing section in which a solid or liquid fuel is placed; a vaporizing section communicated with the fuel placing section in which the fuel is vaporized; and a fuel gas supply port supplying a vaporized fuel vaporized in the vaporizing section to a liquid fuel supply system of the fuel cell.

The fuel container for fuel cell according to the present invention has the fuel placing section and the vaporizing section. This makes it possible to place a high concentration liquid or solid fuel in the fuel placing section, and it is vaporized in the vaporizing section so as to be supplied to the liquid fuel supply system. As a result, it is possible to preferably suppress the lowering of the fuel concentration in the liquid fuel supply system of the fuel cell with simple constitution.

The fuel container for fuel cell according to the present invention can be constituted such that a gas liquid separating section is provided on the fuel gas supply port. This enables the fuel vaporized in the container to be selectively supplied to the liquid fuel supply system of the fuel cell. In the present invention, the gas liquid separating section can be constituted to have, for example, a gas liquid separating film.

The fuel container for fuel cell according to the present invention can be constituted to comprise: a fuel storage chamber in which a solid or fluid fuel is placed; and a vaporizing chamber storing vapor of the fuel vaporized in the fuel storage chamber. By providing the fuel storage chamber and the vaporizing chamber, the solid or liquid fuel can be more surely held in the fuel container, and vaporized so as to be stably supplied to the liquid fuel supply system of the fuel cell.

In the fuel container for fuel cell according to the present invention, the fuel storage chamber and the vaporizing chamber may be partitioned by a gas liquid separating film. This makes it possible to selectively place the vaporized fuel in the vaporizing chamber. As a result, it is possible to make the vaporized fuel more surely supplied to the liquid fuel supply system.

In the fuel container for fuel cell according to the present invention, the fuel may be a solidified material of organic liquid fuel. This makes it possible to suppress the leakage of the fuel component to the outside of the container, even in the case where the fuel component is contained at a high concentration. As a result, it is possible to improve the safety when the fuel container for fuel cell is used. Further, it is possible to make the fuel container downsized as compared with the case where a dilute liquid fuel is stored in the fuel container.

The fuel container for fuel cell according to the present invention may be a fuel cartridge for fuel cell which is detachably provided to the fuel cell. The fuel container for fuel cell according to the present invention is small in size and capable of supplying the fuel with excellent controllability. Thus, by using this fuel container as a portable fuel cartridge for fuel cell, it can be preferably used for a fuel cell and the like which is applied to a portable electric appliance.

According to the present invention, there is provided a fuel cell, comprising: a fuel electrode; a liquid fuel supply system supplying a liquid fuel to the fuel electrode; and a vaporized fuel supply section supplying a vaporized fuel to the liquid fuel supply system; wherein a gas liquid separating section selectively transferring the vaporized fuel is provided between the liquid fuel supply system and the vaporized fuel supply section.

Further, according to the present invention, there is provided a fuel cell, comprising: a fuel electrode; a liquid fuel supply system supplying a liquid fuel to the fuel electrode; and the above described fuel container for fuel cell; wherein a gas liquid separating section selectively transferring vapor of the fuel to the liquid fuel supply system is provided between the fuel container for fuel cell and the liquid fuel supply system.

The fuel cell according to the present invention has the vaporized fuel supply section which supplies vaporized fuel to the liquid fuel supply system which supplies a liquid fuel to the fuel electrode. Further, the fuel cell according to the present invention comprises the fuel cell container for fuel cell, and is constituted so as to make vapor of the fuel in the container supplied to the liquid fuel supply system via the gas liquid separating section. This makes it possible to suppress the lowering of the fuel concentration in the liquid fuel supply system. Further, in the fuel cell according to the present invention, the vaporized fuel is made to pass through the gas liquid separating section so as to be once dissolved in the liquid fuel, and then supplied to the fuel electrode, without being directly supplied to the fuel electrode. Thus, the concentration of the fuel component supplied to the fuel electrode can be stabilized. This eliminates the need for providing auxiliary apparatuses such as a pump for supplying the fuel or an auxiliary power supply for stabilizing the output of the fuel cell. As a result, it is possible to make the fuel cell as a whole downsized and simplified.

The fuel container for fuel cell according to the present invention can be constituted such that an openable and closable shutter member is provided to the fuel gas supply port. Further, the fuel cell according to the present invention can be constituted to comprise a shutter member by which the supply of the vaporized fuel to the liquid fuel supply system starts and stops. This make it possible adjust the supply of the vaporized fuel to the liquid fuel supply system by opening and closing the shutter member according to the use state of the fuel cell. As a result, it is possible to perform the supply of the vaporized fuel to the liquid fuel supply system with more excellent controllability.

In the fuel cell according to the present invention, the liquid fuel supply system may be constituted to comprise a fuel cartridge in which liquid fuel supplied to the fuel electrode is stored, and a fuel collecting section collecting a liquid discharged from the fuel electrode or the oxidant electrode; and wherein the fuel container for fuel cell may be constituted to supply vapor of the fuel to a liquid fuel mixing tank communicated with the fuel cartridge and with the fuel collecting section. With the constitution in which the fuel vapor of the fuel is supplied to the liquid fuel mixing tank, it is possible to suppress the lowering of the concentration of the liquid fuel stored in the mixing tank. Thus, it is possible to stabilize the concentration of the liquid fuel supplied to the fuel electrode, even in the fuel cell having a fuel circulation path, through which the liquid that has passed through the fuel electrode or the oxidant electrode is collected to the mixing tank so as to be supplied to the fuel electrode once more.

According to the present invention, there is provided an operation method of fuel cell having a fuel electrode, a liquid fuel supply system supplying a liquid fuel to the fuel electrode: wherein the fuel cell is operated while supplying a vaporized fuel having a higher concentration than the concentration of the liquid fuel supplied to the fuel electrode.

In the present invention, the fuel cell is operated while the vaporized fuel having a higher concentration than the concentration of the liquid fuel supplied to the fuel electrode is supplied, so that the fuel used during the operation can be dissolved into the liquid fuel as the vaporized fuel and supplied. This makes it possible to stably supply the fuel to the fuel electrode by a simple method. As a result, it is possible to stably operate the fuel cell for a long period of time.

In the operation method of fuel cell, according to the present invention, the fuel cell can be operated by circulating the liquid fuel, while collecting a residual fuel having passed through the fuel electrode or water generated on an oxidant electrode. Even when the fuel cell is operated by circulating the liquid fuel while collecting the residual fuel or water, it is possible to stabilize the fuel supply to the fuel electrode by operating the fuel cell while supplying the vaporized fuel.

Note that any arbitrary combination of each of these kinds of constitution, and any modification between the method and the apparatus stated in the present invention, is also effective as an embodiment of the present invention.

### Effect of the Invention

As described above, according to the present invention, by supplying a vaporized fuel to a liquid fuel supply system of a fuel cell, it is possible to realize a technique which enables the fuel cell to be downsized and the fuel to be stably supplied to a fuel electrode.

### BRIEF DESCRIPTION OF THE DRAWINGS

FIG. 1 is a cross-sectional view schematically showing a constitution of a fuel cell according to the present embodiment;

FIG. 2 is a top view schematically showing a constitution of a fuel cell according to the present embodiment;

FIG. 3 is a view showing FIG. 2 from the line A-A′ direction;

FIG. 4 is a cross-sectional view schematically showing a constitution of a fuel cell according to the present embodiment;

FIG. 5 is a cross-sectional view schematically showing a constitution of a fuel cell according to the present embodiment;

FIG. 6 is a cross-sectional view schematically showing a constitution of a fuel cell according to the present embodiment;

FIG. 7 is a cross-sectional view schematically showing a constitution of a fuel cell according to the present embodiment;

FIG. 8 is a cross-sectional view schematically showing a constitution of a fuel cell according to the present embodiment;

FIG. 9 is a cross-sectional view schematically showing a constitution of a fuel cell according to the present embodiment;

FIG. 10 is a cross-sectional view schematically showing a constitution of a fuel cell according to the present embodiment;

FIG. 11 is a cross-sectional view schematically showing a constitution of a fuel cell according to the present embodiment;

FIG. 12 is a cross-sectional view schematically showing a constitution of a fuel cell according to the present embodiment;

FIG. 13 is a cross-sectional view schematically showing a constitution of a fuel cell according to the present embodiment;

FIG. 14 is a cross-sectional view schematically showing a constitution of a fuel cell according to the present embodiment;

FIG. 15 is a figure to explain a measuring method of a diffusion rate of methanol gas according to Examples;

FIG. 16 is a graph showing a relationship between elapsed time of a fuel container and fuel concentration according to examples;

FIG. 17 is a graph showing a relationship between fuel concentration in the fuel container and diffusion rate according to examples;

FIG. 18 is a cross-sectional view schematically showing a constitution of a fuel cell according to the present embodiment;

FIG. 19 is a graph showing a relationship between power generation time and voltage of the fuel cell according to the example;

FIG. 20 is a view showing a constitution of a shutter of the fuel cell according to the present embodiment;

FIG. 21 is a view showing a constitution of a shutter of the fuel cell according to the present embodiment;

FIG. 22 is a view showing a constitution of a shutter of the fuel cell according to the present embodiment; and

FIG. 23 is a cross-sectional view schematically showing a constitution of a fuel cell according to a present embodiment.

### DESCRIPTION OF SYMBOLS

100 Fuel cell body
101 Unit cell structure
102 Fuel electrode
104 Base body
106 Fuel electrode side catalyst layer
108 Oxidant electrode
110 Base body
112 Oxidant electrode side catalyst layer
114 Solid electrolyte membrane
124 Fuel
126 Oxidizing agent
743 Rotary section
811 Fuel container
853 Partition plate
1117 Pump
1234 Pin section
1235 Cover
1516 Fuel cell
1517 Liquid fuel container
1518 Vaporized fuel container
1519 Gas liquid separating film
1520 Vaporized fuel introducing section
1521 Vaporized fuel
1522 High concentration fuel container
1523 High concentration fuel
1524 Shutter
1525 Collecting pipe
1526 Dripping section
1527 Fuel absorbing section
1528 Vaporized fuel introduction pipe
1529 High concentration fuel supply section
1530 Cover section
1531 Sliding plate
1532 High concentration fuel cartridge
1533 Spring section
1534 Sliding plate
1535 Stopper
1536 Main body connecting section
1537 Spring section
1538 Pressing plate
1539 Cartridge connecting section
1540 Stopper
1541 Sealing material
1542 Hook
1543 Measurement container
1544 First container
1545 Second container
1546 Porous PTFE film
1547 Movable plate
1548 Supporting section
1549 Partition wall

### BEST MODE FOR CARRYING OUT THE INVENTION

In the following, embodiments according to the present invention will be described with reference to the accompanying drawings. Note that in all the figures, common components are designated with the same symbols, and their explanation is appropriately omitted.

### First Embodiment

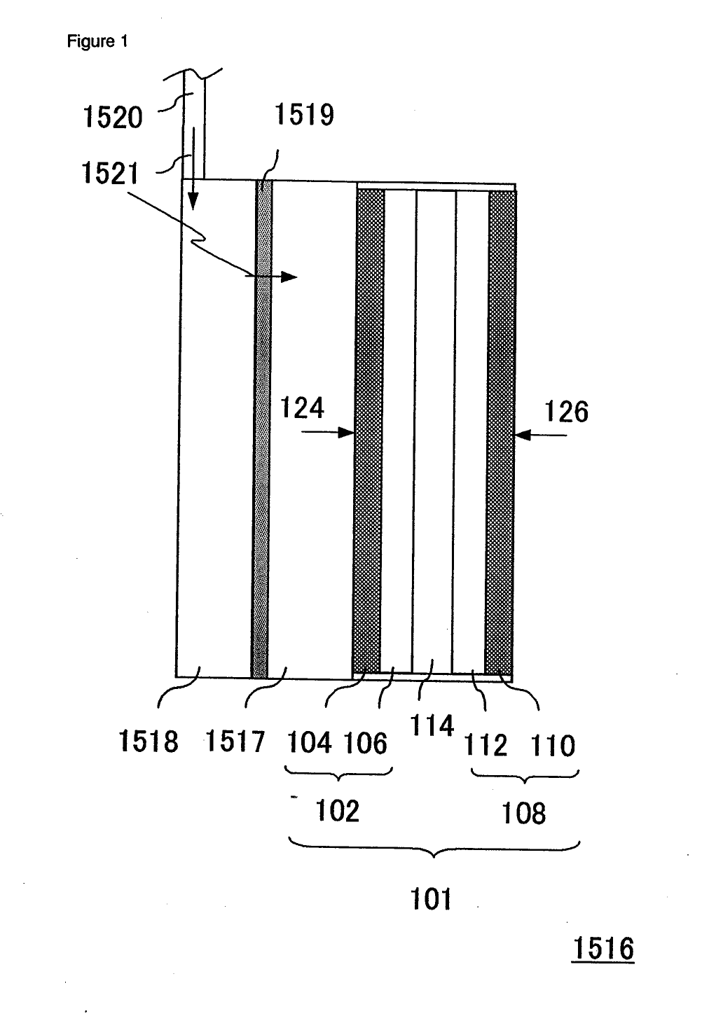

FIG. 1 is a cross-sectional view schematically showing a constitution of a fuel cell according to this embodiment. Fuel cell 1516 in FIG. 1 comprises a unit cell structure 101, a liquid fuel container 1517, a vaporized fuel container 1518, a gas liquid separating film 1519, and a vaporized fuel introducing section 1520. In FIG. 1, there is shown an example of a constitution provided with one unit cell structure 101, but as described below in the second and succeeding embodiments, it may also be constituted to comprise plural unit cell structures 101.

The unit cell structure 101 includes a fuel electrode 102, an oxidant electrode 108, and a solid electrolyte membrane 114. In the fuel cell shown in FIG. 1, a fuel 124 in the liquid fuel container 1517 is directly supplied to the fuel electrode 102.

The solid electrolyte membrane 114 has a role to separate the fuel electrode 102 from the oxidant electrode 108 and to transfer a hydrogen ion between the fuel electrode 102 and the oxidant electrode 108. For this reason, it is preferred that the solid electrolyte membrane 114 is made of a film having a high hydrogen ion conductivity. Further, it is preferred that the solid electrolyte membrane 114 is chemically stable and has a high mechanical strength. As a material constituting the solid electrolyte membrane 114, an organic polymer, which has a polar group such as a strong acid group including sulfone group, phosphate group, or the like and a weak acid group including carboxyl group or the like, is preferably used. Examples of such organic polymer include: aromatic condensation polymers such as sulfonated poly(4-phenoxybenzoyl-1,4-phenylene) and alkylsulfonated polybenzimidazole; sulfone group-containing perfluorocarbon (Nafion® made by Du Pont Co., Ltd., Aciplex made by Asahi Chemical Industry Co., Ltd.); carboxyl group-containing perfluorocarbon (Flemion S film (registered trademark) made by Asahi Glass Co., Ltd.); sulfonate polyether ether ketone; sulfonated polyether sulfone, and the like.

The fuel electrode 102 and the oxidant electrode 108 can be constituted such that a fuel electrode side catalyst layer 106 and an oxidant electrode side catalyst layer 112, each of which includes a carbon particle carrying a catalyst and a fine particle of a solid electrolyte, are respectively formed on a base body 104 and a base body 110. Examples of the catalyst include platinum, an alloy of platinum and ruthenium, and the like. As the catalysts of the fuel electrode 102 and the oxidant electrode 108, a same catalyst may be used, or different catalysts may also be used.

Examples of the catalyst of fuel electrode side catalyst layer 106 include platinum, gold, silver, ruthenium, rhodium, palladium, osmium, iridium, cobalt, nickel, rhenium, lithium, lanthanum, strontium, yttrium, or an alloy of them, and the like. As the catalyst of the oxidant electrode side catalyst layer 112 used for the oxidant electrode 108, it is possible to use the same materials as those of the fuel electrode side catalyst layer, and to use the above exemplified materials. Note that as the catalysts of the fuel electrode side catalyst layer 106 and the oxidant electrode side catalyst layer 112, a same catalyst may be used, or different catalysts may also be used.

As the base body for both of the fuel electrode 102 and the oxidant electrode 108, it is possible to use a porous base body such as a carbon paper, a body formed of carbon, a body sintered of carbon, a sintered metal, and a foamed metal.

The vaporized fuel container 1518 is connected to the liquid fuel container 1517 via the gas liquid separating film 1519. Further, the vaporized fuel container 1518 is communicated with the vaporized fuel introducing section 1520. The vaporized fuel 1521 is supplied from the vaporized fuel introducing section 1520 to the vaporized fuel container 1518, and further supplied to the liquid fuel container 1517 via the gas liquid separating film 1519.

As a material of the wall of the liquid fuel container 1517 and the vaporized fuel container 1518, it is possible to use a resin such as polyolefins including polypropylene, polyethylene and the like, polycarbonate, polyvinyl chloride, polyether ether ketone, polysulfone, silicone, or a copolymer or a mixture of these materials.

The gas liquid separating film 1519 can be formed of a material which is capable of making its surface tension to a liquid fuel 124 different from its surface tension to a gas such as air. Alternatively, a member which is obtained by making the surface of a porous body covered with such a material can also be used as the gas liquid separating film 1519. As the material of the gas liquid separating film 1519, for example, a liquid repellent material can be used. For example, when the fuel 124 is methanol or an aqueous solution of methanol, a film suppressing permeation of methanol is used.

Specifically, examples of the material used for the gas liquid separating film 1519 include perfluoropolymers such as polytetrafluoroethylene (hereinafter referred to as PTFE) and tetrafluoroethylene-hexafluoropropylene copolymer (FEP); polyfluoroalkyl acrylates such as poly(1H,1H-perfluorooctyl methacrylate), poly(1H,1H,2H,2H-perfluorodecyl acrylate); fluoroolefins such as polyvinylidene fluoride and polyfluorinated ethylene propylene. Further, it is also possible to use polyvinylidene chloride, polyacetal, a copolymer resin of butadiene and acrylonitrile, or the like.

Among these, the perfluoropolymer such as PTFE is preferably used because of the excellent balance between a permeableness and selectivity of the gas and a property of film formation. The gas liquid separating film 1519 desirably has a thin film thickness because it needs to allow a gas such as air to be efficiently permeated. Although depending upon physical properties of the film, the gas liquid separating film 1519 is preferably formed to be a thin film having a thickness of 5 μm or less. The use of perfluoropolymer such as PTFE makes it possible to stably form such nonporous thin film. Further, a fluoroalkyl acrylate polymer such as poly(1H,1H-perfluorooctyl methacrylate) or poly(1H,1H,2H,2H-perfluorodecyl acrylate) is preferably used, because it has an excellent property of film formation and can be easily formed into a thin film, and also has a permeableness and selectivity for carbon dioxide. The fluoroalkyl acrylate polymer can be obtained by esterifying a part of or whole of polycarboxylic acid with fluoroalcohol.

A molecular weight of the polymer constituting the gas liquid separating film 1519 is preferably set to 1000 to 1,000,000, and more preferably to 3000 to 100,000. When the molecular weight is too large, it may be difficult to prepare a solution, and to make a restricted permeation layer formed to be thin. When the molecular weight is too small, a sufficient restricted permeability may not be obtained. Note that the molecular weight here is the number average molecular weight which can be evaluated by GPC (Gel Permeation Chromatography).

Further, a gas permeable nonporous film may also be laminated on a porous film, so as to be used as the gas liquid separating film 1519. At this time, the above described films can be used as the nonporous film. Further, the porous film is a film made of, for example, polyethersulfone, an acrylic copolymer, or the like. Specifically, the film thickness of the porous film, examples of which include Goretex® made by Japan Gore Tex Co. Ltd., Versapor® made by a Nippon Paul Co. Ltd., Supor® made by a Nippon Paul Co. Ltd. and the like may be set to, for example, 50 μm or more to 500 μm or less. This makes it possible to improve a mechanical strength of the gas liquid separating film 1519. Thus, the fuel cell 1516 with an excellent mechanical strength can be stably obtained.

The above described laminated film can be formed, for example, by applying a solution of the above described resin which serves as a material of the nonporous film on the surface of the porous film by a spin-coating method, and by drying the applied solution.

Further, a gas permeable porous film may also be used as the gas liquid separating film 1519. At this time, a material used for the nonporous gas liquid separating film 1519 may also be used as a material of the porous film, so as to be made porous. For example, a porous film made of a perfluoropolymer such as a porous PTFE film can be used. In this case, the film thickness of the gas liquid separating film 1519 can be set to, for example, 10 μm or more to 500 μm or less.

In the fuel cell 1516, the fuel 124 is supplied to the fuel electrode 102 of the unit cell structure 101 from the liquid fuel container 1517. The fuel 124 means a liquid fuel supplied to the unit cell structure 101, and includes an organic solvent which is a fuel component as an essential component. Further, the fuel 124 can be formed into an aqueous solution of the organic solvent serving as the fuel component. Further, methanol, ethanol, dimethyl ether, or other alcohols can be used as the fuel 124 stored in the liquid fuel container 1517. Further, it is possible to use a liquid hydrocarbon such as cycloparaffin, and a liquid fuel such as formalin, formic acid, hydrazine or the like. Further, alkali can be also added to the liquid fuel. This makes it possible to increase an ion conductivity of a hydrogen ion.

Further, the vaporized fuel 1521 is supplied to the vaporized fuel container 1518 from the vaporized fuel introducing section 1520. The vaporized fuel introducing section 1520 can be, for example, a pipe for guiding a vaporized fuel 1521 stored in a predetermined position to the vaporized fuel container 1518. The vaporized fuel introducing section 1520 may also be, for example, a chamber which stores the vaporized fuel 1521. The supply of the vaporized fuel 1521 can be performed by a method in which the liquid fuel or the solid fuel containing the fuel component at a higher concentration than the concentration of the fuel 124 is used, so as to be vaporized. At this time, the vaporizing chamber in which the fuel component in the high concentration liquid or solid fuel is vaporized can be constituted to be communicated with the vaporized fuel introducing section 1520. The specific method for supplying the vaporized fuel 1521 will be described in detail in the second and succeeding embodiments.

The vaporized fuel in the vaporized fuel container 1518 is transferred to the liquid fuel container 1517 via the gas liquid separating film 1519 in accordance with a decrease of the fuel 124 stored in the liquid fuel container 1517. For example, when the fuel component is a volatile alcohol such as methanol, a vaporized alcohol is dissolved and diffused into the fuel 124 stored in the liquid fuel container 1517. This construction makes it possible to supply only the necessary amount of the fuel component which is reduced with the operation of the fuel cell 1516 from the vaporized fuel container 1518. Thus, it is not necessary to provide an auxiliary apparatus such as a pump for supplying the fuel or an auxiliary power supply for stabilizing the output of the fuel cell 1516. As a result, it is possible to simplify the constitution of the fuel cell 1516 as a whole.

Further, since a fuel component is once vaporized and then supplied to the liquid fuel container 1517, it is possible to use a high concentration liquid or solidified fuel as a raw material of the vaporized fuel 1521. This makes it possible to downsize the fuel cell 1516 as a whole.

Further, since a suitably diluted liquid fuel 124 is supplied to the fuel electrode 102, it is possible to preferably suppress an occurrence of crossover even in the case where the fuel 124 is a methanol aqueous solution or the like.

In this way, the fuel cell 1516 is constituted to have the vaporized fuel 1521 in contact with the liquid fuel 124 via the gas liquid separating film 1519, thereby allowing the vaporized fuel 1521 to be supplied to the fuel 124. Therefore, the fuel cell 1516 is capable of stably exhibiting an excellent output capacity in spite of its small-size and simplified constitution.

Note that an oxidizing agent 126 is supplied to the oxidant electrode 108 of the unit cell structure 101. As the oxidizing agent 126, air can be generally used but oxygen gas may also be supplied.

Although the whole surface of the partition wall between the unit cell structure 101 and the vaporized fuel container 1518 is formed as the gas liquid separating film 1519 in the fuel cell 1516, a part of the partition wall between the unit cell structure 101 and the vaporized fuel container 1518 may also be formed as the gas liquid separating film 1519.

Although the fuel cell 1516 is constituted such that the vaporized fuel 1521 is supplied to the vaporized fuel container 1518 from the vaporized fuel introducing section 1520, the vaporized fuel introducing section 1520 need not be provided. In this case, as described in the second and succeeding embodiments, for example, the vaporized fuel 1521, or the solid or liquid fuel from which the vaporized fuel 1521 is generated can be placed in the vaporized fuel container 1518.

### Second Embodiment

In the present embodiment, there is described a constitution of a fuel cell which has plural unit cell structures 101 as described in the first embodiment. Here, a constitution in which plural unit cell structures 101 are stacked in a plane is described as an example. The fuel cell according to the present embodiment is applicable to small electric appliances including a portable telephone, portable personal computers such as a note type, a PDA (Personal Digital Assistant), various kinds of cameras, a navigation system, and a portable music reproducing player.

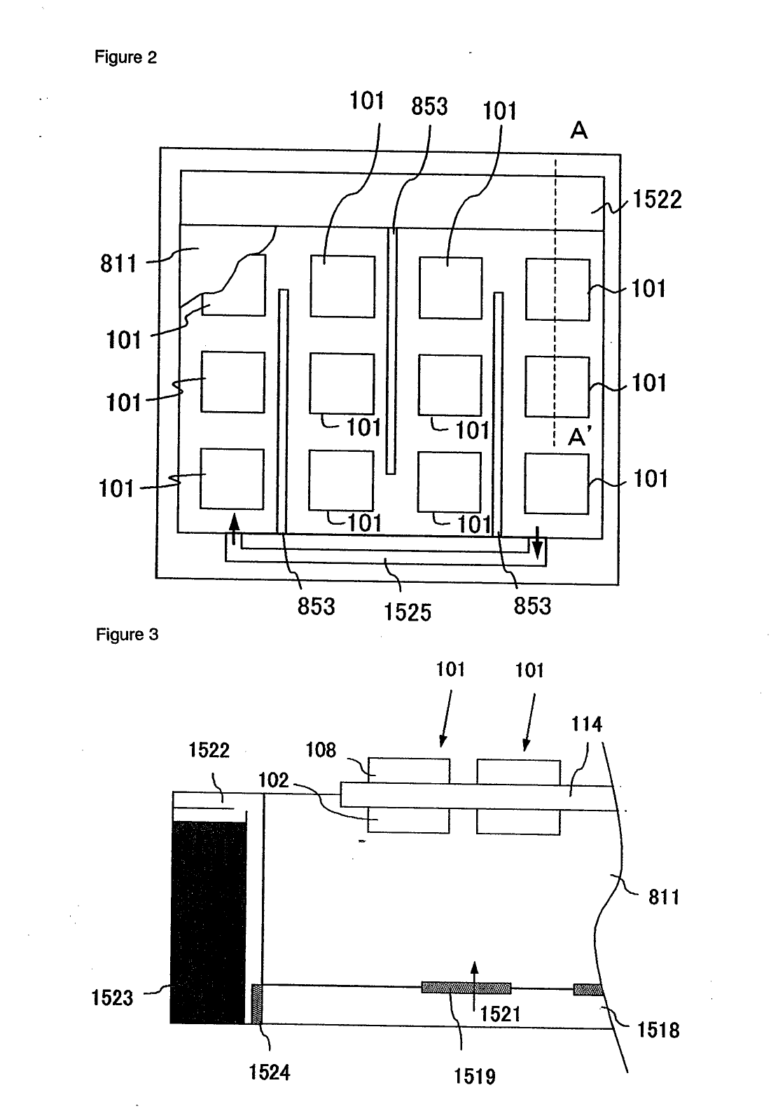

FIG. 2 is a view schematically showing a constitution of a fuel cell according to the present embodiment. The fuel cell shown in FIG. 2 includes plural unit cell structures 101, a fuel container 811, a partition plate 853, and a collecting pipe 1525. The collecting pipe 1525 collects a liquid that has passed through a fuel electrode 102 of the unit cell structure 101, and water generated by a cell reaction in an oxidant electrode, and serves as a path through which the collected liquid and water are returned to the fuel container 811.

FIG. 3 is a cross-sectional view along the line A-A′ in FIG. 2. The fuel cell shown in FIG. 3 is constituted such that plural fuel electrodes 102 are provided on one surface of a single sheet of solid electrolyte membrane 114, that plural oxidant electrodes 108 are provided on the other surface, and that plural unit cell structures 101 shares the solid electrolyte membrane 114 so as to be arranged in a same plane. Further, a fuel container 811 is provided so as to cover and surround the outer side of the fuel electrode 102, and a fuel 124 stored in the fuel container 811 is directly supplied to the fuel electrode 102.

The fuel container 811 shown in FIG. 2 and FIG. 3 corresponds to the liquid fuel container 1517 in FIG. 1, and a fuel 124 supplied to the fuel electrode 102 is stored in the fuel container 811. Further, in FIG. 3, a vaporized fuel container 1518 is provided on the bottom part of the fuel container 811, and a gas liquid separating film 1519 is provided at a part between the vaporized fuel container 1518 and the fuel container 811. Further, a high concentration fuel container 1522 communicated with the vaporized fuel container 1518 via a shutter 1524 is provided on the side of the fuel container 811.

The fuel 124 stored in the fuel container 811 is made to flow along plural partition plates 853 provided in fuel container 811, and is successively supplied to the plural unit cell structures 101. The fuel 124 which is supplied to the unit cell structures 101 but not used for the cell reaction is returned to the fuel container 811 from a collecting pipe 1525. A ratio of water in the fuel 124 is increased in accordance with the use of the fuel cell, as shown by the above described formula (1) and formula (2), so that a concentration of the fuel component in the fuel 124 is decreased.

Then, a vaporized fuel 1521 is supplied to the fuel container 811 via the gas liquid separating film 1519 provided between the high concentration fuel container 1522 and the fuel container 811. Here, a high concentration fuel 1523 stored in the high concentration fuel container 1522 is vaporized to pass through the shutter 1524, and is then dissolved in the fuel 124 stored in the fuel container 811 via the gas liquid separating film 1519. This makes it possible to stably supply the fuel 124 having a predetermined concentration to the fuel electrode 102 of the unit cell structure 101.

The shutter 1524 is constituted so as to separate the vaporized fuel container 1518 from the high concentration fuel container 1522, and to be openable and closable. By opening and closing the shutter 1524, a concentration of a fuel vapor in the vaporized fuel container 1518 can be adjusted. When the shutter 1524 is opened, the vaporized fuel 1521 can be transferred from the high concentration fuel container 1522 to the vaporized fuel container 1518. The shutter 1524 can be constituted as follows.

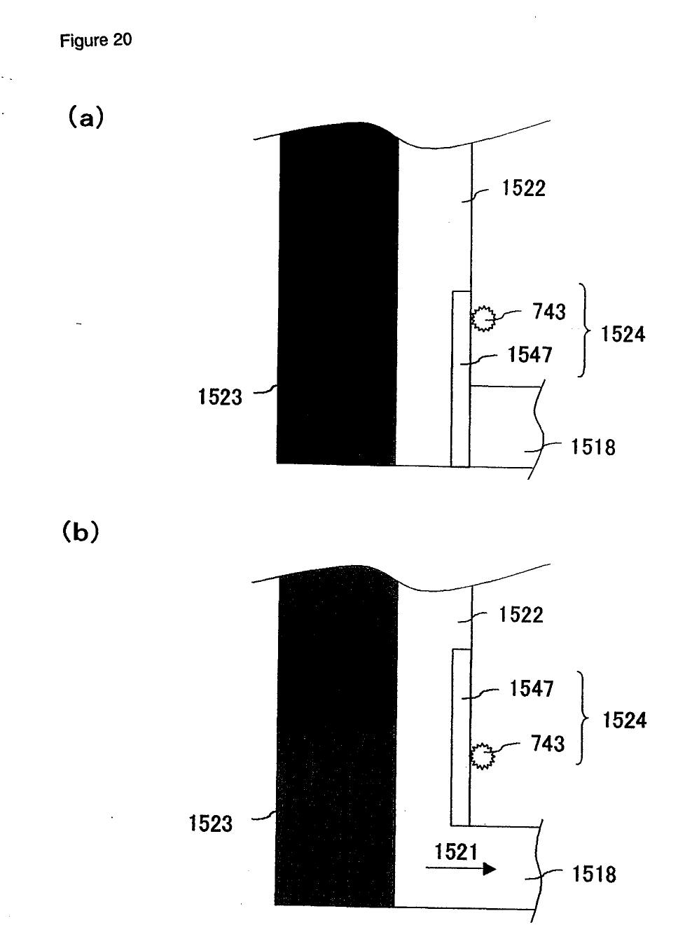

FIG. 20(a) and FIG. 20(b) are views showing a neighborhood part of a shutter 1524 of the fuel cell shown in FIG. 3. FIG. 20(a) shows a state where the shutter 1524 is closed, and FIG. 20(b) shows a state where the shutter 1524 is opened. The shutter 1524 consists of a movable plate 1547 and a rotary section 743. The movable plate 1547 slides by the rotation of the rotary section 743 engaged with the movable plate 1547, to open and close the shutter 1524.

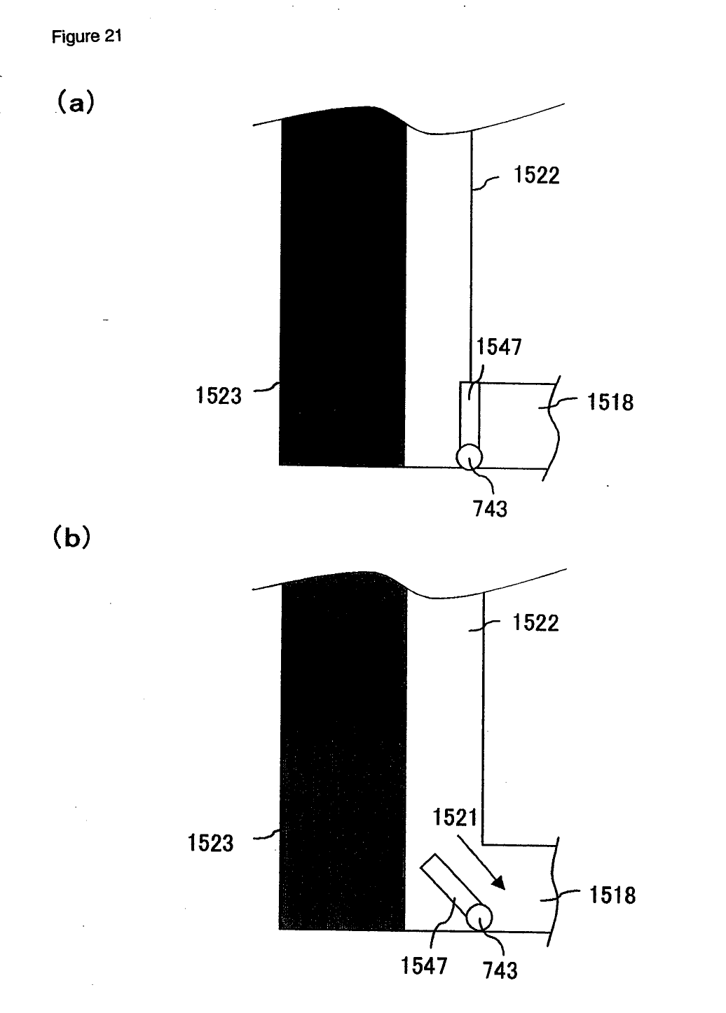

FIG. 21(a) and FIG. 21(b) are views showing another constitution of a shutter 1524. FIG. 21(a) and FIG. 21(b) also show a neighborhood part of the shutter 1524 of the fuel cell in FIG. 3. FIG. 21(a) shows a state where the shutter 1524 is closed, and FIG. 21(b) shows a state where the shutter 1524 is opened.

In FIG. 21(a) and FIG. 21(b), the opening and closing between the high concentration fuel container 1522 and the vaporized fuel container 1518 are performed by the rotation of a movable plate 1547 constituting a shutter 1524 along a rotary section 743 as an axis.

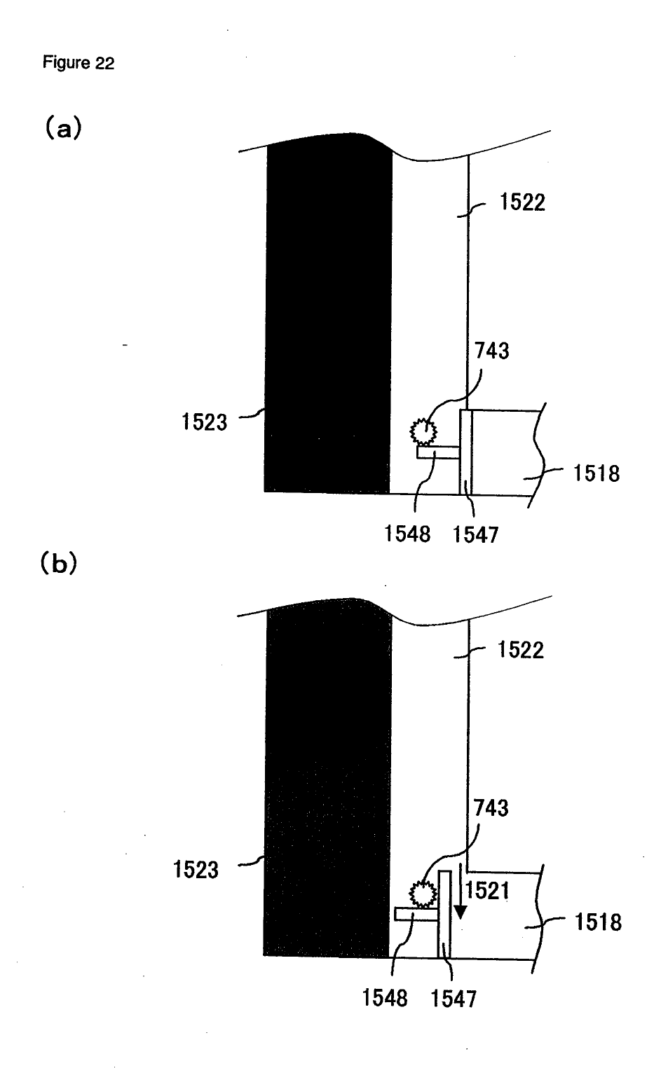

FIG. 22(a) and FIG. 22(b) are views showing another constitution of a shutter 1524. FIG. 22(a) and FIG. 22(b) also show a neighborhood part of the shutter 1524 of the fuel cell in FIG. 3. FIG. 22(a) shows a state where the shutter 1524 is closed, and FIG. 22(b) shows a state where the shutter 1524 is opened.

In FIG. 22(a) and FIG. 22(b), a supporting section 1548 which supports a movable plate 1547 constituting a shutter 1524 is engaged with a rotary section 743. Thus, the supporting section 1548 slides by the rotation of the rotary section 743, thereby enabling the movable plate 1547 fixed to the supporting section 1548 to open and close one end of the vaporized fuel container 1518.

By the provision of shutter 1524, it is possible to stop the supply of the vaporized fuel 1521, when the fuel cell is not used. Note that the shutter 1524 may be constituted so as to be switched in two states of open and close, or to make a coverage ratio of the end surface of the vaporized fuel container 1518 adjusted in the predetermined stage. With the constitution in which a coverage ratio of the interface between the vaporized fuel container 1518 and the high concentration fuel container 1522 is adjustable, it is possible to further precisely adjust the supply of the vaporized fuel 1521 by using the shutter 1524. Further, although not shown in FIG. 2 and FIG. 3, a control section which controls the opening and closing of the shutter 1524 can also be provided in the fuel cell. This makes it possible to further surely adjust the opening and closing of the shutter 1524.

In the fuel cell according to the present embodiment, the high concentration fuel 1523 is vaporized and supplied to the fuel container 811. Thus, when the fuel in the fuel container 811 is consumed, a necessary amount of the fuel component is supplied as the vaporized fuel 1521. For example, when the fuel component is a material having an excellent volatility such as methanol, the high concentration fuel 1523 is naturally vaporized even at room temperature and is easily dissolved and diffused in the liquid fuel 124 in the fuel container 811. This makes it possible to stably supply the fuel with a simple constitution, without using an auxiliary apparatus for fuel supply such as a pump. At this time, the provision of the gas liquid separating film 1519 and the shutter 1524 makes it possible to selectively transfer the vaporized fuel 1521 to the side of the fuel container 811 in predetermined timing. Further, the liquid fuel 124 is supplied to the fuel electrode 102 from the fuel container 811, so that it is possible to stably adjust the fuel 124 supplied to the fuel electrode 102 to a predetermined concentration. Further, the high concentration fuel 1523 is stored in the high concentration fuel container 1522, so that it is possible to downsize the high concentration fuel container 1522.

Note that in the present embodiment, the arrangement of the gas liquid separating film 1519 and the shutter 1524 is not limited to the above, and various kinds of constitution can be adopted. In the following, fuel cells with different arrangements are exemplified.

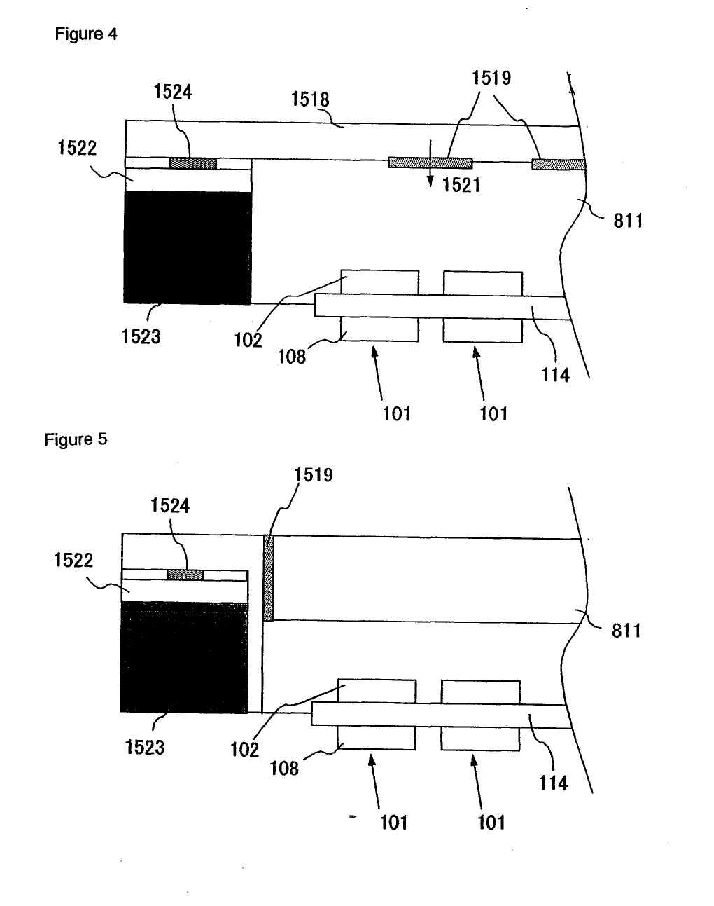

For example, FIG. 4 is a cross-sectional view showing another constitution of a fuel cell according to the present embodiment. In FIG. 4, the fuel container 811 is provided so as to cover the upper part of the unit cell structure 101. Further, the shutter 1524 is provided on the upper part of the high concentration fuel container 1522. With this constitution, it is possible to shorten the moving path of the vaporized fuel 1521 naturally vaporized in the high concentration fuel container 1522 to the vaporized fuel container 1518 in comparison with the constitution shown in FIG. 3. This makes it possible to further downsize and simplify the constitution of the fuel cell.

FIG. 5 is a cross-sectional view showing another constitution of a fuel cell according to the present embodiment. The basic constitution of the fuel cell in FIG. 5 is the same as that of the fuel cell in FIG. 4, but is different in that the gas liquid separating film 1519 is provided on the side face of fuel container 811. In this constitution, the vaporized fuel 1521 can also be stably supplied to the fuel container 811.

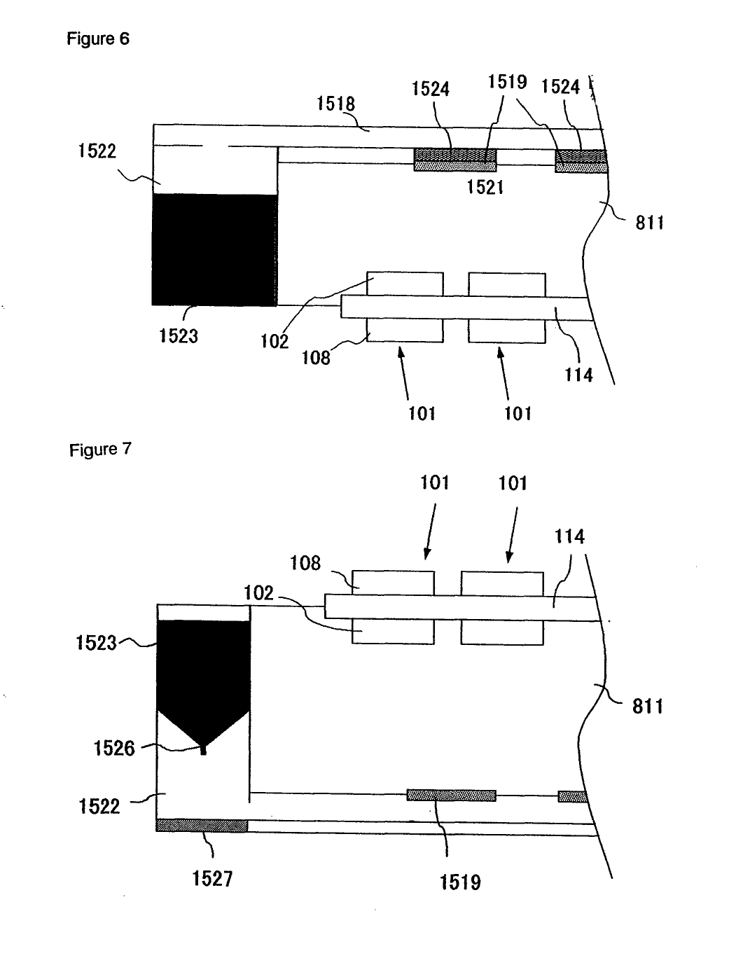

Further, FIG. 6 is a cross-sectional view showing another constitution of a fuel cell according to the present embodiment. The basic constitution of the fuel cell in FIG. 6 is also the same as that of the fuel cell in FIG. 4, but is different in that the gas liquid separating film 1519 and the shutter 1524 are provided so as to be adjacent to each other. The gas liquid separating film 1519 is provided on the side of the fuel container 811, and the shutter 1524 is provided on the side of the high concentration fuel container 1522. In this constitution, when the shutter 1524 is closed, the gas liquid separating film 1519 is covered by the shutter 1524, to makes it possible to adjust the supply of the vaporized fuel 1521 to the fuel 124 stored in the fuel container 811 more precisely.

Further, in the above examples, the gas liquid separating film 1519 may be formed of, for example, a material whose aperture ratio is changed in accordance with a concentration of the fuel 124 in the fuel container 811. This makes it possible to impart a function for adjusting the supply of the vaporized fuel 1521 to the gas liquid separating film 1519 itself.

In the fuel cell constituted as described above, it is possible to use a liquid fuel or a solid fuel containing a fuel component at high concentration as the high concentration fuel 1523. By using a solidified fuel as the high concentration fuel 1523, it is possible to suppress the leakage of the high concentration fuel 1523. Thereby, the fuel cell can be used more safely. Also, even when a liquid fuel is used as the high concentration fuel 1523, the liquid fuel is supplied to the fuel container 811 as the vaporized fuel 1521, so that it is possible to suppress the leakage of the liquid of the high concentration fuel 1523.

When a high concentration liquid fuel is used as the high concentration fuel 1523, it is possible to use, for example, an aqueous solution or a raw liquid which have a fuel component concentration in the range of about 60 to 100% by volume. By using an organic liquid fuel or an aqueous solution thereof which have a fuel component concentration of 60% by volume or more, it is possible to store, in a container, the liquid fuel having a higher concentration than that of the fuel 124 supplied to the liquid fuel supply system of the fuel cell. This makes it possible to stably obtain a fuel container which is small and capable of supplying the fuel for a long period of time.

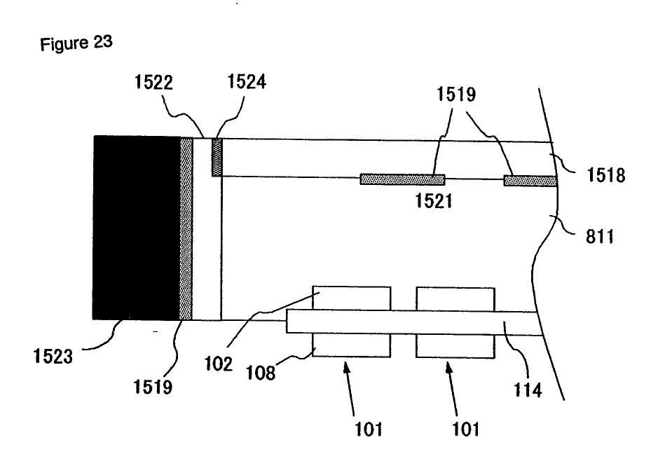

Further, when a liquid fuel is used as the high concentration fuel 1523, the fuel cell may be constituted as follows. FIG. 23 is a cross-sectional view showing another constitution of a fuel cell according to the present embodiment.

The basic constitution of the fuel cell shown in FIG. 23 is the same as that of the fuel cell shown in FIG. 4, but is different in that the shutter 1524 is provided on the side face which separates the vaporized fuel container 1518 from the high concentration fuel container 1522, and in that the gas liquid separating film 1519 is provided in the high concentration fuel container 1522, and the high concentration fuel container 1522 is partitioned into two chambers by the gas liquid separating film 1519.

By providing the gas liquid separating film 1519 in the high concentration fuel container 1522, so as to make the high concentration fuel container 1522 partitioned into two chambers, it is possible to suppress the leakage of the high concentration fuel 1523 to the outside of the high concentration fuel container 1522 when the one chamber of the high concentration fuel container 1522 is be used as a high concentration fuel storage chamber to make the high concentration fuel 1523 as a liquid fuel surely present in the high concentration fuel storage chamber. Further, the other chamber can be used as a vaporizing chamber of high concentration fuel 1523. Here, the vaporizing chamber is a chamber brought into contact with the vaporized fuel container 1518, and the shutter 1524 is provided between the vaporizing chamber and the vaporized fuel container 1518. With this constitution, it is possible to make a vaporized fuel 1521 vaporized from the liquid fuel stored in the high concentration fuel storage chamber selectively present in the vaporizing chamber from the gas liquid separating film 1519. It is also possible to adjust the opening and closing of the shutter 1524, and to thereby adjust the amount of the vaporized fuel 1521 supplied to the vaporized fuel container 1518. Further, it is possible to more selectively supply the vaporized fuel 1521 to a fuel cell body 100. As such gas liquid separating film 1519, it is possible to use a gas permeable nonporous film exemplified in the first embodiment, and the like.

Note that it is possible to make the high concentration liquid fuel impregnated in a wicking material which is a porous material capable of absorbing liquid fuel. The wicking material can be formed of, for example, a porous material such as a foam. Specifically, a resin which is, for example, polyurethane, melamine, polyamides such as nylon, polyethylene, polypropylene, polyesters such as polyethylene terephthalate, cellulose, or polyacrylonitrile, is used as the wicking material.

Further, when a solid fuel is used as the high concentration fuel 1523, it is possible to gelatinize a liquid of the fuel component, and to use the gelatinized fuel component. The gelling agent used for the gelatinized fuel can be suitably selected and used in accordance with the kind of the fuel component, from various materials which are stable in the use temperature of the fuel cell. For example, when the fuel component is alcohol such as methanol, it is possible to use, as the gelling material, a cross-linked product of polymer material such as polyacrylamide, polyethylene oxide, polyacrylate and polyvinyl alcohol. These materials may be used independently, or may be used by combining plural kinds of these materials. Further, for example, a cellulose derivative such as a hydroxyethyl cellulose, a hydroxypropyl cellulose, and a carboxymethyl cellulose, and a cross-linked product of so-called semisynthetic polymer material such as a carboxyvinyl polymer (carbomer) may also be used.

Further, a solid fuel can also be obtained without using the polymer gelling agent. For example, when the fuel component is alcohol, a solid fuel can be prepared by obtaining a gel-like sodium stearate by saponification reaction in a mixture formed by mixing a fatty acid such as sodium stearate with a hydroxide such as sodium hydroxide. Further, instead of sodium hydroxide, a compound which exhibits alkalinity in an aqueous solution, such as borax Na₂[B₄O₅(OH)₄]8H₂O, may also be used.

In the fuel cells shown in FIG. 2 to FIG. 6, the high concentration fuel 1523 may be liquid or solid. Further, when the high concentration liquid fuel is used as the high concentration fuel 1523, the fuel cell can also be constituted as follows. FIG. 7 is a cross-sectional view showing another constitution of a fuel cell according to the present embodiment. The basic constitution of the fuel cell shown in FIG. 7 is the same as that of the fuel cell shown in FIG. 3, but is different in that the supply of the vaporized fuel 1521 is controlled by adjusting a dripping rate or a dripping amount of the high concentration fuel 1523 in the high concentration fuel container 1522.

In FIG. 7, the high concentration fuel container 1522 has a dripping section 1526, and a fuel absorbing section 1527 is provided in a position to which the high concentration fuel 1523 is dripped from the dripping section 1526. For example, a porous body absorbing high concentration fuel 1523 can be used as the fuel absorbing section 1527. As a material of the porous body, those having a resistance against the fuel component may be used, which is, for example, a metal such as SUS, Ti, Ni, and Al; a metal oxide such as silica, alumina, and zirconia; a ceramic such as silicon carbide, titanium carbide, and zeolite; or a polymer material such as cellulose and polyurethane. Note that as another polymer material, the material used as the above described wicking material can also be used.

The fuel cell shown in FIG. 7 is constituted such that the high concentration fuel 1523 dripped from the dripping section 1526 is absorbed in the fuel absorbing section 1527, and thereafter, the fuel absorbed in the fuel absorbing section 1527 is vaporized so as to be supplied to the vaporized fuel container 1518. Thereby, it is possible to adjust the supply of the vaporized fuel 1521 by adjusting the dripping amount or the dripping rate from the dripping section 1526, without an opening and closing shutter 1524.

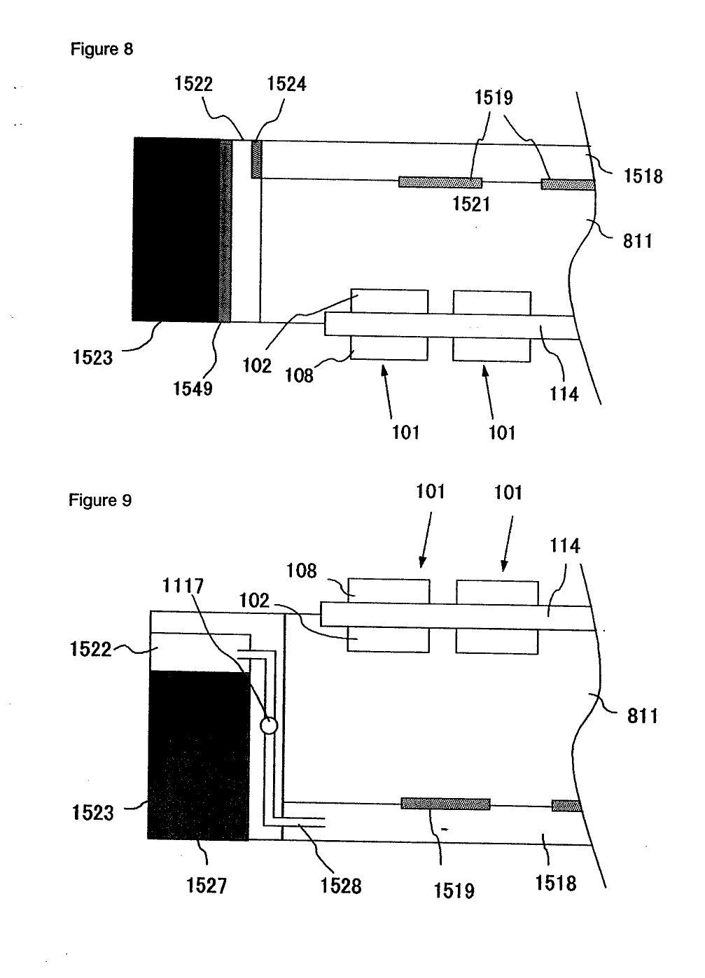

Further, when a solid fuel is used as the high concentration fuel 1523, the fuel cell may be constituted as follows. FIG. 8 is a cross-sectional view showing another constitution of a fuel cell according to the present embodiment. The basic constitution of the fuel cell shown in FIG. 8 is the same as that of the fuel cell shown in FIG. 4; but is different in that the shutter 1524 is provided on the side face which separates the vaporized fuel container 1518 from the high concentration fuel container 1522, and in that a partition wall 1549 is provided in the high concentration fuel container 1522.

The partition wall 1549 is a member which separates the high concentration fuel container 1522 into a fuel storage chamber and a vaporizing chamber, which is made of a gas permeable material. Specifically, as a material of the partition wall 1549, a material which can be used for the fuel absorbing section 1527 in the fuel cell shown in FIG. 7 can be used. By providing the partition wall 1549 in the high concentration fuel container 1522, it is possible that the high concentration fuel 1523 as a solid fuel is held in a predetermined region of the high concentration fuel container 1522 to suppress the leakage of the high concentration fuel to the outside of the container, and that the high concentration fuel 1523 is vaporized so as to be surely supplied to the side of the fuel container 811. Further, by using a solid fuel as the high concentration fuel 1523, it is possible to vaporize the high concentration fuel 1523 and to stably supply the vaporized fuel to fuel container 811, independently of the arrangement direction of the high concentration fuel container 1522. Further, the leakage of the high concentration fuel 1523 can be suppressed. As a result, the fuel cell can be more preferably used for a portable electric appliance.

Note that in the above constitution, a small pump may also be used instead of the shutter 1524. FIG. 9 is a cross-sectional view showing a constitution of a fuel cell having a pump. The basic constitution of the fuel cell in FIG. 9 is the same as that of the fuel cell shown in FIG. 3, but is different in that the high concentration fuel in high concentration fuel container 1522 is vaporized, and the vaporized fuel 1521 is supplied to the vaporized fuel container 1518 from the vaporized fuel introduction pipe 1528 by using a pomp 1117.

As the pump 1117, for example, a piezoelectric element such as a small-sized piezoelectric motor whose power consumption is very small can be used. Further, although not shown in FIG. 9, it is possible to provide a control section which controls the operation of the pump 1117, for the fuel cell. With this constitution, it is possible to adjust the supply amount of the vaporized fuel 1521 by adjusting the exhausting rate of the pump 1117, and to thereby surely control the supply of the vaporized fuel 1521.

Further, in the above described constitution, when the high concentration fuel 1523 is a high concentration liquid fuel or a gelatinized fuel which has fluidity in a certain extent, the high concentration fuel container 1522 may be constituted so as to enable the supply of the high concentration fuel 1523 to be performed. Here, a case of the fuel cell shown in FIG. 4 is explained as an example.

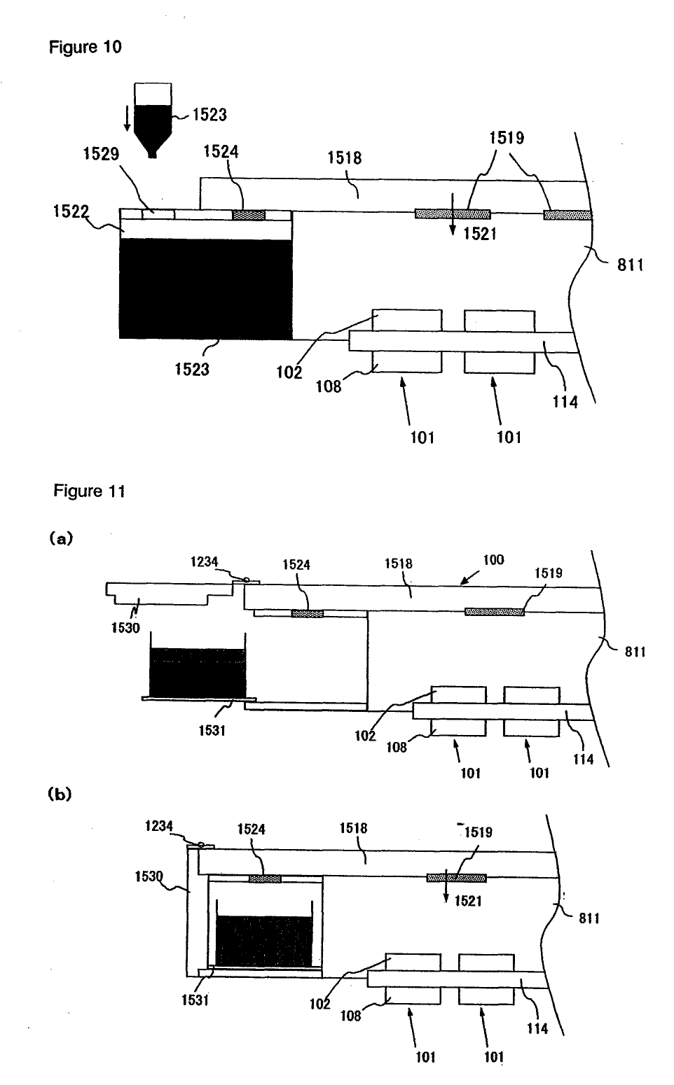

FIG. 10 is a cross-sectional view showing a constitution of a fuel cell according to the present embodiment. The basic constitution of the fuel cell in FIG. 10 is the same as that of the fuel cell shown in FIG. 4, but is different in that an openable and closable high concentration fuel supply section 1529 which is communicated with the storage chamber of the high concentration fuel 1523 is provided for the high concentration fuel container 1522. Note that the high concentration fuel supply section 1529 is provided for the wall of the upper section of the high concentration fuel container 1522 in FIG. 10, but the high concentration fuel supply section 1529 can also be provided for the side wall of the high concentration fuel container 1522.

By providing the high concentration fuel supply section 1529, even when the high concentration fuel 1523 is consumed due to the use of the fuel cell, it is possible to inject and supply the high concentration fuel 1523 from the high concentration fuel supply section 1529. This makes it possible to stably operate the fuel cell for a longer period of time.

As the constitution of high concentration fuel supply section 1529, it is possible to adopt various kinds of constitution, by which the high concentration fuel supply section 1529 can be opened when the high concentration fuel 1523 is supplied and can be surely closed during the use of the fuel cell except it. For example, the high concentration fuel supply section 1529 may be constituted by an opening passing through the wall of the high concentration fuel container 1522 and a closing member closing the opening. At this time, the closing member may be constituted so as to be fit to the wall with screws or the like, and to thereby suppress the leakage of the high concentration fuel 1523. Further, for example, the high concentration fuel supply section 1529 may also be constituted by an opening passing through the wall of the high concentration fuel container 1522 and a cap covering the opening. Further, for example, the high concentration fuel supply section 1529 may also be constituted by an opening passing through the wall of the high concentration fuel container 1522 and a sliding plate which can be made to slide along the wall to thereby open and close the opening.

Further, when the high concentration fuel 1523 is a solid fuel, it is possible to supply the solid fuel by providing an openable and closable cover section for the high concentration fuel container 1522. FIG. 11(a) and FIG. 11(b) are views showing a constitution of a fuel cell having a high concentration fuel container 1522 providing a cover section. The basic constitution of the fuel cell shown in FIG. 11(a) and FIG. 11(b) is the same as that of the fuel cell in FIG. 4, but is different in that an openable and closable cover section 1530 is provided on the side wail of the high concentration fuel container 1522. A casing constituting the upper wall surface of the vaporized fuel container 1518 and the cover section 1530 constituting the side wall surface of the high concentration fuel container 1522 are connected with each other by a hinge having a pin section 1234. Further, although not shown in FIG. 11(a) and FIG. 11(b), the high concentration fuel container 1522 has a fixing member for fixing the cover section 1530 in the closed state.

In the fuel cell shown in FIG. 11(a) and FIG. 11(b), the side face of the high concentration fuel container 1522 is opened by making the cover section 1530 rotated along the pin section 1234 as a rotation center. When the high concentration fuel 1523 is supplied to the high concentration fuel container 1522, the cover section 1530 is opened, and a sliding plate 1531 provided on the bottom section of the high concentration fuel container 1522 slides toward the outside of the high concentration fuel container 1522, so as to be drawn out. FIG. 11(a) shows a state where the cover section 1530 is opened, and the sliding plate 1531 is drawn out. Then, a new solid fuel is set on the sliding plate 1531, and the sliding plate 1531 slides toward the inside of the high concentration fuel container 1522, to store the high concentration fuel 1523 in the inside of the high concentration fuel container 1522. Then, the cover section 1530 is closed (FIG. 11 (b)).

Note that in FIG. 11, although the high concentration fuel container 1522 is constituted so as to be opened and closed by making the cover section 1535 rotated along the pin section 1234 as the rotation center, the method for opening and closing the cover section is not limited to this constitution and the cover section can be mounted by such as a method for fitting the cover section by hooking it by a claw or the like, and a slide lock method.

Further, in the above described fuel cell, the constitution in which the gas liquid separating film 1519 is provided in the vaporized fuel container 1518 is shown, but the gas liquid separating film 1519 may also be provided in the high concentration fuel container 1522 in the fuel cell according to the present embodiment. For example, in the fuel cell shown in FIG. 6, the gas liquid separating film 1519 and the shutter 1524 may also be provided in the high concentration fuel container 1522. In this case, the vaporized fuel 1521 in the high concentration fuel container 1522 can be transferred to the vaporized fuel container 1518 via the gas liquid separating film 1519, by opening the shutter 1524.

Further, in the fuel cell shown in FIG. 3, plural unit cell structures 101 are arranged to share a single sheet of solid electrolyte membrane 114, but plural unit cell structures 101, each of which is independently provided with a solid electrolyte membrane 114, may also be arranged to be integrated in a plane. This makes it possible to suppress the transfer of protons in the plane direction of solid electrolyte 114, when potentials of adjacent unit cell structures 101 are different from each other.

### Third Embodiment

In the fuel cell of the above described embodiment, the high concentration fuel container 1522 storing the high concentration fuel 1523 may be a fuel cartridge. The fuel cartridge can be attached to and detached from the fuel cell body, and can be exchanged and carried.

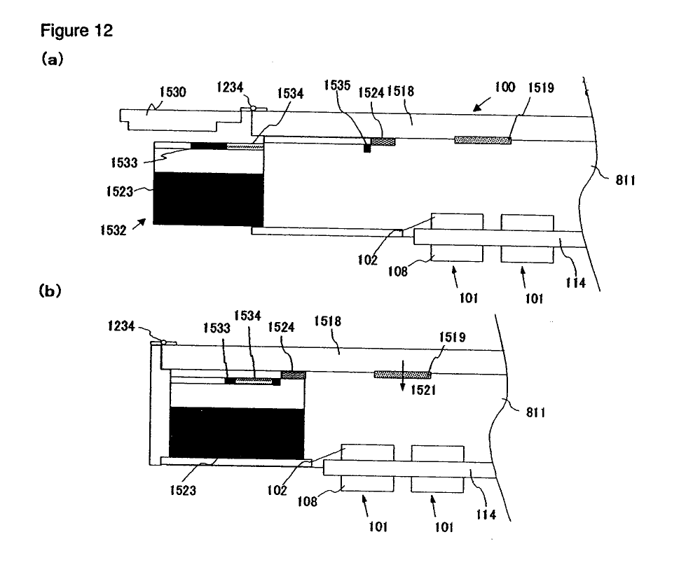

FIG. 12(a) and FIG. 12(b) are cross-sectional views schematically showing a constitution of a fuel cartridge and a high concentration fuel container 1522 in which the fuel cartridge is stored. This fuel cell consists of a fuel cell body 100 and a high concentration fuel cartridge 1532. Similarly to the fuel cell shown in FIG. 11, an openable and closable cover section 1530 is constituted so as to be attached on the side wall of the fuel cell body 100, and to enable the high concentration fuel cartridge 1532 to be inserted.

As shown in FIG. 12 (a), the high concentration fuel cartridge 1532 has a storage chamber for storing a high concentration fuel 1523, a spring section 1533, and a sliding plate 1534. When a force is applied to the sliding plate 1534 from a side thereof, the spring section 1533 is contracted. Further, the high concentration fuel container 1522 has a stopper 1535 which fixes the sliding plate 1534 of the high concentration fuel cartridge 1532.

The exchange of the high concentration fuel cartridge 1532 is performed in such a manner that the cover section 1530 is opened and then the high concentration fuel cartridge 1532 is inserted from the side of the high concentration fuel container 1522. At this time, when the high concentration fuel cartridge 1532 is stored in the high concentration fuel container 1522, the spring section 1533 is expanded and contracted from the position where the sliding plate 1534 is brought into contact with the stopper 1535. Thus, by making the high concentration fuel cartridge 1532 completely stored and making the cover section 1530 closed and fixed by a fixing member (not shown), the high concentration fuel cartridge 1532 can be fixed in the high concentration fuel container 1522 (FIG. 12 (b)).

In the fuel cell shown in FIG. 12(a) and FIG. 12(b), it is possible to make the high concentration fuel cartridge 1532 surely fixed and stably held in the inside of the fuel cell body 100 by providing the spring section 1533. Therefore, the fuel cell can be preferably used for a portable electric appliance or the like. Further, the exchange of the high concentration fuel cartridge 1532 can be easily performed with a simple constitution. This makes it possible to facilitate the supply of the high concentration fuel 1523 and to stably operate the fuel cell for a long period of time.

Note that in the fuel cell shown in FIG. 12(a) and FIG. 12(b), a gas liquid separating film 1519 may be provided for the high concentration fuel cartridge 1532. For example, in the case where the high concentration fuel cartridge 1532 is inserted in the fuel cell body 100, the gas liquid separating film 1519 can be provided so as to face the shutter 1524. This enables the vaporized fuel 1521 to be more surely transferred to the vaporized fuel container 1518 from the high concentration fuel cartridge 1532.

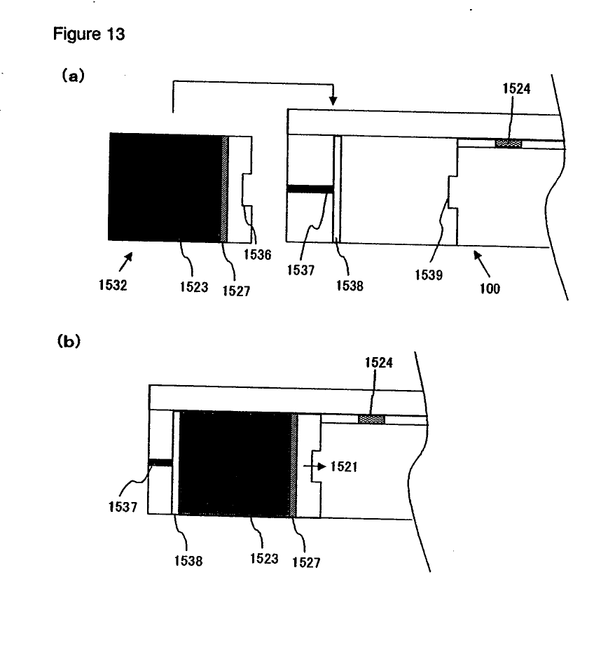

Further, the constitution of the high concentration fuel cartridge 1532 and the method for mounting the high concentration fuel cartridge 1532 to the high concentration fuel container 1522 are not limited to the above described constitution, but various kinds of constitution can be adopted. For example, FIG. 13(a) and FIG. 13(b) are cross-sectional views showing another constitution of a high concentration fuel cartridge 1532 and a high concentration fuel container 1522.

In FIG. 13 (a), the high concentration fuel cartridge 1532 has a storage chamber in which a solid high concentration fuel 1523 is stored and a fuel absorbing section 1527 which partitions the storage chamber from the outside in the high concentration fuel cartridge 1532. A main body connecting section 1536 is also provided for the high concentration fuel cartridge 1532. A part of the wall of the main body connecting section 1536 is formed in a recessed shape, so as to fit into a cartridge connecting section 1539 which is formed in a projected shape and which is provided for the high concentration fuel container 1522. Further, the high concentration fuel container 1522 is provided with a pressing plate 1538 which fixes the high concentration fuel cartridge 1532, and a spring section 1537 which can be expanded and contracted so as to enable the position of the pressing plate 1538 to be movable.

In mounting the high concentration fuel cartridge 1532 to the high concentration fuel container 1522, a space sufficient for making the spring section 1537 contracted and for making the high concentration fuel cartridge 1532 inserted into the high concentration fuel container 1522 is formed, and thereby the high concentration fuel cartridge 1532 is mounted. At this time, by making the main body connecting section 1536 and the cartridge connecting section 1539 fit with each other, and by bringing the pressing plate 1538 into contact with the wall surface of the high concentration fuel cartridge 1532, the high concentration fuel cartridge 1532 can be fixed in the high concentration fuel container 1522 (FIG. 13 (b)).

Because the recessed section of the main body connecting section 1536 and the projected section of the cartridge connecting section 1539 are opening, the high concentration fuel 1523 vaporized in the high concentration fuel container can be transferred to the fuel cell body 100 by connecting the high concentration fuel cartridge 1532. Note that the high concentration fuel cartridge 1532 can be used in such a manner that the opening of the main body connecting section 1536 is sealed by, for example, a sealing member before the use of the high concentration fuel cartridge 1532, and that the sealing member is peeled off when the high concentration fuel cartridge 1532 is used.

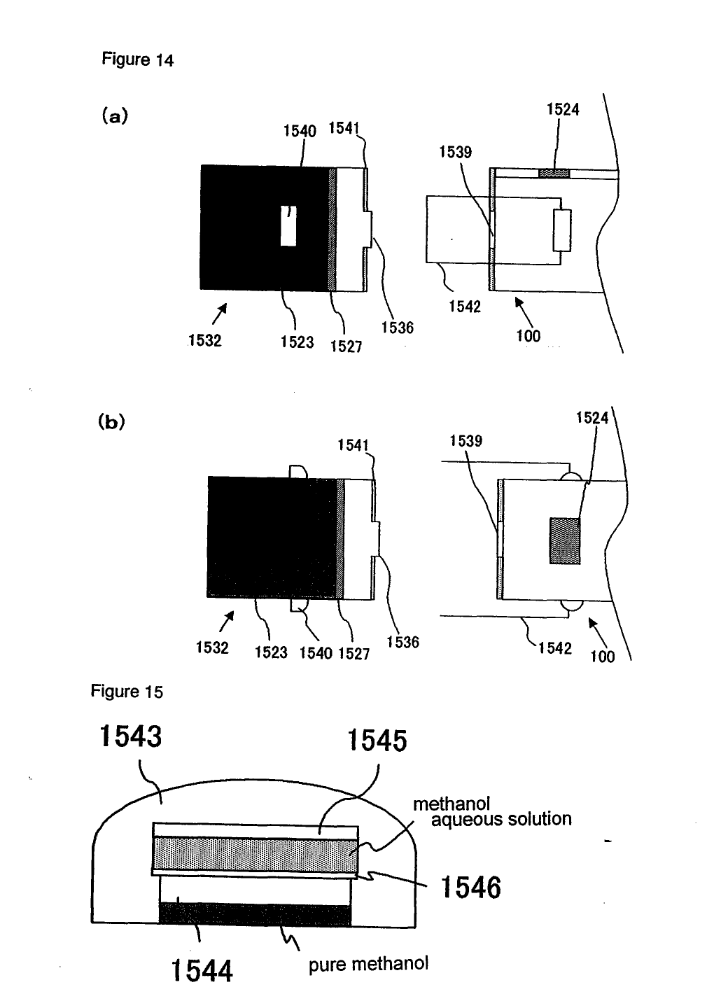

Further, FIG. 14(a) and FIG. 14(b) are views showing another constitution of a high concentration fuel cartridge 1532 and a high concentration fuel container 1522 which is constituted so as to enable the high concentration fuel cartridge 1532 to be mounted thereto. FIG. 14(a) is a cross-sectional view of the high concentration fuel cartridge 1532 and the high concentration fuel container 1522. FIG. 14(b) is also a top view of them. The basic constitution of the fuel cell shown in FIG. 14(a) and FIG. 14(b) is the same as that of the fuel cell shown in FIG. 13(a) and FIG. 13(b), but is different in that the high concentration fuel cartridge 1532 is constituted so as to be fixed by a hook 1542 and a stopper 1540, instead of the method for fixing the high concentration fuel cartridge 1532 by the pressing plate 1538 and the spring section 1537.

As shown in FIG. 14(a), the stopper 1540 which fixes the hook 1542 is provided for the high concentration fuel cartridge 1532, and the hook 1542 is provided for the cartridge connecting section 1539 of the high concentration fuel container 1522. Thus, by making the cartridge connecting section 1539 fit into the main body connecting section 1536 and making the hook 1542 engage the stopper 1540, the high concentration fuel cartridge 1532 can be fixed in the high concentration fuel container 1522 (FIG. 14 (b)).

Note that in FIG. 14(a) and FIG. 14(b), a sealing material 1541 is stuck on the circumference of a main body connecting section 1536 in the high concentration fuel 1523. As the sealing material 1541 which is an elastic member, it is possible to use, for example, a polymer material having a low gas permeability and flexibility. As such a material, it is possible to use, for example, an elastomer such as ethylene propylene rubber and silicone rubber. When ethylene propylene rubber is used as the sealing material 1541, it is possible to use a copolymer of ethylene and propylene (EPM), or a copolymer of ethylene, propylene and a third component (EPDM).

In the fuel cells shown in FIG. 13 and FIG. 14, by using a material having an excellent gas liquid separating property for the fuel absorbing section 1527 provided in the high concentration fuel cartridge 1532, it is possible to preferably use this as the gas liquid separating film 1519. This enables the vaporized fuel more surely transferred to the vaporized fuel container 1518.

Further, in the high concentration fuel cartridge 1532 of the fuel cells shown in FIG. 13 and FIG. 14, a gas liquid separating film 1519 may be provided instead of the fuel absorbing section 1527. Thereby, even when the high concentration fuel container 1522 is a cartridge type, it is possible to make the fuel container surely held in a predetermined region of the high concentration fuel cartridge 1532. Further, there may be a constitution in which the vaporized fuel 1521 vaporized from the high concentration fuel 1523 is selectively passed through the gas liquid separating film 1519, and is transferred to the fuel cell body 100. Thereby, similarly to the fuel cell shown in FIG. 23, even when the high concentration fuel 1523 is a liquid, it is possible to suppress the leakage of the high concentration fuel 1523. As such gas liquid separating film 1519, it is possible to use, for example, a gas permeable nonporous film as exemplified in the first embodiment.

In this way, in the constitution according to the present embodiment, it is possible to use a portable cartridge type container as the high concentration fuel container 1522 which contains the fuel component at a high concentration. This enables a fuel cell as a whole to be downsized, and to stably exhibit an outstanding output performance for a long period of time. Further, with the use of a solid fuel as a high concentration fuel 1523, even in the case where a cartridge type is adopted, it is possible to suppress the leakage of fuel when the cartridge is carried, and to further improve the safety in use.

In the above, the present invention is explained on the basis of the embodiments. These embodiments are merely exemplary, and it will be understood by persons skilled in the art that various modifications may be made by a combination of each of the components and treatment processes of these embodiments, and that these modifications are also included within the scope of the present invention.

For example, the above described embodiments are explained by taking, as an example, a constitution in which the vaporized fuel 1521 is transferred into the fuel 124 via the gas liquid separating film 1519 constituting a part of the wall of the liquid fuel container 1517 and the fuel container 811, but the supply section of the vaporized fuel 1521 can also be provided for any part of the liquid fuel supply system. For example, when a liquid fuel supply pipe is provided for a liquid fuel supply system, a gas liquid separating film 1519 may be provided for a part of the wall of the liquid fuel supply pipe, so as to make the liquid fuel supply pipe communicated with the vaporized fuel introducing section 1520 or the vaporized fuel container 1518 via the gas liquid separating film

Further, the above described embodiments is mainly explained to be an embodiment, in which the high concentration fuel 1523 stored in the high concentration fuel container 1522 is naturally vaporized, but an adjustment member which adjusts a vaporization amount of the high concentration fuel 1523 may also be provided. The adjustment of the vaporization amount can be performed, for example, by adjusting the temperature of the high concentration fuel container 1522, or by giving a vibration to the high concentration fuel container 1522.

In the above embodiments, a small pump 1117 may also be used to supply the liquid fuel 124 to the fuel electrode 102. For example, a pump which can be used in the fuel cell shown in FIG. 9 can be used as the pump 1117.

### Example

(Measurement of Diffusion Rate of Methanol Gas into Methanol Aqueous Solution)

In the present embodiment, a rate at the time when methanol gas is diffused into a methanol aqueous solution was measured at first. FIG. 15 is a cross-sectional view showing a container used for the measurement. In FIG. 15, a first container 1544, a porous PTFE film 1546, and a second container 1545 were successively stacked in this order from the bottom in a measurement container 1543. The first container 1544 and the second container 1545 are communicated with each other via the porous PTFE film 1546, so as to enable gas in the first container 1544 to be selectively transferred to the side of the second container 1545.

Pure methanol was stored in the first container 1544, and 12 ml of pure water was stored in the second container 1545. Methanol in the first container 1544 is vaporized to become methanol gas, which is then transferred to the side of the second container 1545 via the porous PTFE film 1546. Then, the methanol gas is dissolved in the pure water stored in the second container 1545, thereby causing the methanol concentration to be increased.

The temporal change of the concentration of liquid methanol in the second container 1545 was measured by using a measurement container 1543. Note that the concentration of liquid methanol in the second container 1545 at the time of starting the measurement is 0% by volume. Further, the concentration of liquid methanol in the second container 1545 was measured by gas chromatography. The area in which the porous PTFE film 1546 is in contact with methanol gas was set to 10 cm².

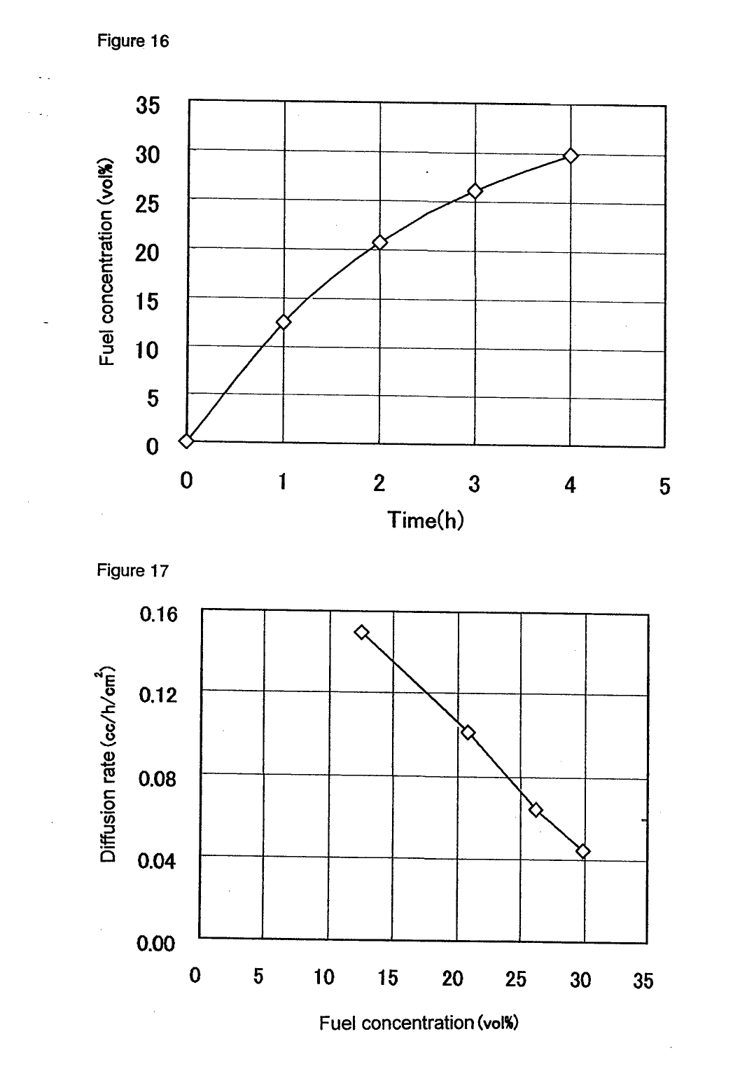

FIG. 16 is a graph showing a relationship between the elapsed time and the methanol concentration in the second container 1545. Further, FIG. 17 is a graph showing a relationship between the concentration of liquid methanol in the second container 1545 and the diffusion rate, based on the result shown in FIG. 16. Here, from a calculation about the unit cell structure 101 of the fuel cell explained in the above described embodiment, for example, pure methanol of 0.016 ml/h/cm² is needed in order to supply a current with a current density of 60 mA/cm². From FIG. 17, it can be seen that the methanol supply amount sufficient for the above described operating condition is obtained, when the method according to the present embodiment is used. For this reason, it is possible to stably operate the fuel cell for a long period of time by using the method in which the high concentration methanol is gasified and supplied to fuel 124.

Further, as shown in FIG. 16 and FIG. 17, the diffusion rate was decreased as the methanol concentration in the second container 1545 is increased. Then, when the methanol concentration in the second container 1545 is increased, the diffusion of the high concentration methanol is stopped, and the concentration of liquid methanol in the second container 1545 is made constant. For this reason, it is possible to make the concentration of liquid methanol in the second container 1545 kept constant by using the porous PTFE film 1546. As a result, by applying this method to a liquid fuel supply system of fuel cell, it is possible to stably supply liquid fuel of a predetermined concentration to the fuel electrode 102 without using an auxiliary apparatus, such as a pump.

### (Application to Fuel Cell)

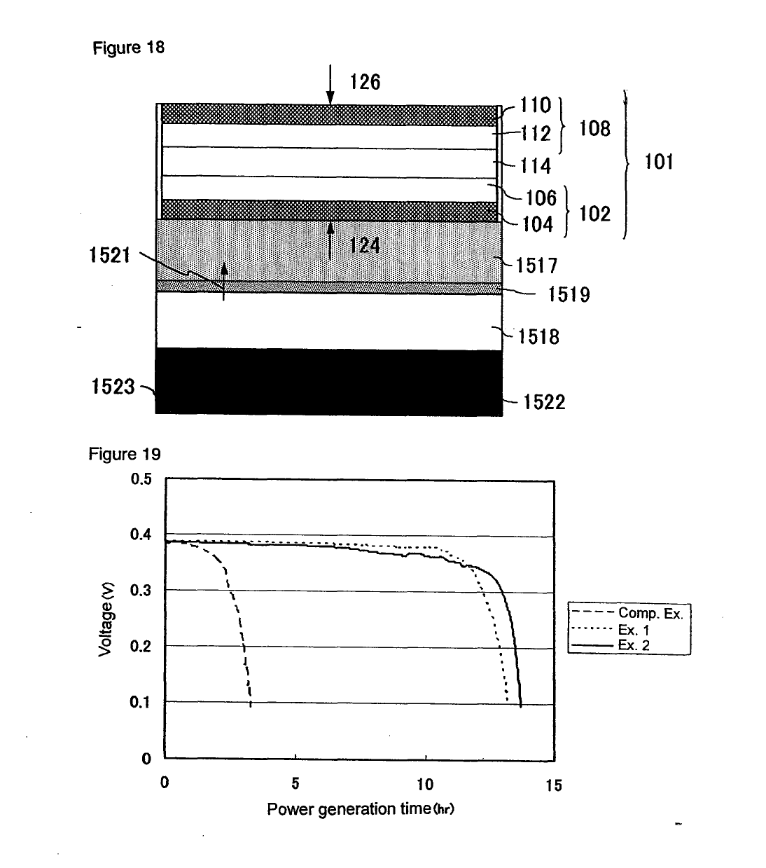

Then, the above described constitution was applied to a fuel cell in order to evaluate the power generation property of the fuel cell. FIG. 18 is a cross-sectional view schematically showing a constitution of the fuel cell used in the present embodiment. The fuel cell shown in FIG. 18 basically has the same constitution as that of fuel cell 1516 shown in FIG. 1. A high concentration fuel container 1522 communicating with a vaporized fuel container 1518 in FIG. 18 corresponds to the vaporized fuel introducing section 1520 in FIG. 1. In this constitution, a high concentration fuel 1523 placed in the high concentration fuel container 1522 is vaporized, so as to be transferred, as a vaporized fuel, from the high concentration fuel container 1522 to the vaporized fuel container 1518 and a gas liquid separating film 1519 in this order, and then, is dissolved in a fuel 124 stored in a liquid fuel container 1517. Note that although not shown in FIG. 18, a circulation path through which the fuel 124 is circulated was provided.

In the fuel cell shown in FIG. 18, the temporal change of voltage at the time when the fuel cell was discharged at a constant current of 1 A at room temperature was measured. A porous film of PTFE was used as the gas liquid separating film 1519. Further, the fuel cell was operated by circulating the fuel 124.

A methanol aqueous solution of 5% by volume was used as the fuel 124. Further, pure methanol or solidified (gelatinized) methanol fuel gelatinized by using a gelling agent was used as the high concentration fuel 1523. Table 1 shows the fuel used in examples and a comparative example. In Table 1, “fuel” corresponds to the fuel 124 in FIG. 18, and “high concentration fuel” corresponds to the high concentration fuel 1523 in FIG. 18.

TABLE 1

| | | | area in |
|---|---|---|---|
| | | | contact with |
| | | | vaporized |
| | fuel | high concentration fuel | fuel (cm²) |
| Ex. 1 | 5 vol % MeOHaq. | MeOH | 5 |
| | 23 ml | 5 ml | |
| Ex. 2 | 5 vol % MeOHaq. | solid fuel 5 g | 10 |
| | 23 ml | (equivalent to MeOH 6 ml) | |
| Comp. | 5 vol % MeOHaq. | — | 5 |
| Ex. | 28 ml | | |

FIG. 19 is a graph showing a relationship between the power generation time and the voltage. From FIG. 19, it was confirmed that a stable output property was exhibited for longer than 10 hours in any cases where pure methanol or solid methanol fuel were used as the high concentration fuel 1523. On the other hand, in the comparative example, although the used amount of methanol itself was equivalent to that of the examples, the supply of methanol from the high concentration fuel 1523 was not performed, as a result of which the voltage drop after the start of power generation was significant.

From the above results, it was confirmed that the fuel cell could be stably operated for a long period of time, by supplying fuel in such a manner that high concentration fuel 1523 was used so as to be once vaporized and then dissolved in fuel 124.

1-14. (canceled)

15. A fuel container for fuel cell in which a solid or liquid fuel is placed, comprising a fuel gas supply port for supplying vapor of the fuel stored in the container to a liquid fuel supply system of the fuel cell.

16. The fuel container for fuel cell according to claim 15, wherein a gas liquid separating section is provided on the fuel gas supply port.

17. The fuel container for fuel cell according to claim 15, further comprising:
a fuel storage chamber in which a solid or fluid fuel is placed; and
a vaporizing chamber storing vapor of the fuel vaporized in the fuel storage chamber.

18. The fuel container for fuel cell according to claim 17, wherein the fuel storage chamber and the vaporizing chamber are partitioned by a gas liquid separating film.

19. The fuel container for fuel cell according to claim 15, wherein the fuel is a solidified material of an organic liquid fuel.

20. The fuel container for fuel cell according to claim 15, being a fuel cartridge for fuel cell which is detachably provided to the fuel cell.

21. The fuel container for fuel cell according to claim 15, wherein an openable and closable shutter member is provided to the fuel gas supply port.

22. A fuel container for fuel cell, comprising:
a fuel placing section in which a solid or liquid fuel is placed;
a vaporizing section communicated with the fuel placing section in which the fuel is vaporized; and
a fuel gas supply port supplying a vaporized fuel vaporized in the vaporizing section to a liquid fuel supply system of the fuel cell.

23. The fuel container for fuel cell according to claim 22, wherein a gas liquid separating section is provided on the fuel gas supply port.

24. The fuel container for fuel cell according to claim 22, further comprising:
a fuel storage chamber in which a solid or fluid fuel is placed; and
a vaporizing chamber storing vapor of the fuel vaporized in the fuel storage chamber.

25. The fuel container for fuel cell according to claim 24, wherein the fuel storage chamber and the vaporizing chamber are partitioned by a gas liquid separating film.

26. The fuel container for fuel cell according to claim 22, wherein the fuel is a solidified material of an organic liquid fuel.

27. The fuel container for fuel cell according to claim 22, being a fuel cartridge for fuel cell which is detachably provided to the fuel cell.

28. The fuel container for fuel cell according to claim 22, wherein an openable and closable shutter member is provided to the fuel gas supply port.

29. A fuel cell, comprising: a fuel electrode; a liquid fuel supply system supplying a liquid fuel to the fuel electrode; and a vaporized fuel supply section supplying a vaporized fuel to the liquid fuel supply system; wherein a gas liquid separating section selectively transferring the vaporized fuel is provided between the liquid fuel supply system and the vaporized fuel supply section.

30. The fuel cell according to claim 29, further comprising a shutter member by which the supply of the vaporized fuel to the liquid fuel supply system starts and stops.

31. A fuel cell, comprising: a fuel electrode; a liquid fuel supply system supplying a liquid fuel to the fuel electrode; and the fuel container for fuel cell according to claim 15; wherein a gas liquid separating section selectively transferring vapor of the fuel to the liquid fuel supply system is provided between the fuel container for fuel cell and the liquid fuel supply system.

32. The fuel cell according to claim 31, further comprising a shutter member by which the supply of the vaporized fuel to the liquid fuel supply system starts and stops.

33. The fuel cell according to claim 31:
wherein the liquid fuel supply system comprises,
a fuel cartridge in which liquid fuel supplied to the fuel electrode is stored, and
a fuel collecting section collecting a liquid discharged from the fuel electrode or the oxidant electrode; and
wherein the fuel container for fuel cell is constituted to supply vapor of the fuel to a liquid fuel mixing tank communicated with the fuel cartridge and with the fuel collecting section.

34. A fuel cell, comprising: a fuel electrode; a liquid fuel supply system supplying a liquid fuel to the fuel electrode; and the fuel container for fuel cell according to claim 22; wherein a gas liquid separating section selectively transferring vapor of the fuel to the liquid fuel supply system is provided between the fuel container for fuel cell and the liquid fuel supply system.

35. The fuel cell according to claim 34, further comprising a shutter member by which the supply of the vaporized fuel to the liquid fuel supply system starts and stops.

36. The fuel cell according to claim 34:
wherein the liquid fuel supply system comprises,
a fuel cartridge in which liquid fuel supplied to the fuel electrode is stored, and
a fuel collecting section collecting a liquid discharged from the fuel electrode or the oxidant electrode; and
wherein the fuel container for fuel cell is constituted to supply vapor of the fuel to a liquid fuel mixing tank communicated with the fuel cartridge and with the fuel collecting section.

37. An operation method of fuel cell having a fuel electrode, a liquid fuel supply system supplying a liquid fuel to the fuel electrode:
wherein the fuel cell is operated while supplying a vaporized fuel having a higher concentration than the concentration of the liquid fuel supplied to the fuel electrode.

38. The operation method of fuel cell according to claim 37, wherein the fuel cell is operated by circulating the liquid fuel, while collecting a residual fuel having passed through the fuel electrode or a water generated on an oxidant electrode.
